(19) United States
(12) Patent Application Publication
(10) Pub. No.: US 2007/0242042 A1
(43) Pub. Date: Oct. 18, 2007

(54) FREE STANDING JOYSTICK

(75) Inventor: Michael B. Kelly, Safety Harbor, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/279,493

(22) Filed: Apr. 12, 2006

(51) Int. Cl. G09G 5/08

(52) U.S. Cl. 345/161

(57) ABSTRACT

A free standing joystick that is unrestricted in terms of its DOF of movement is disclosed, which can detect and represent all of the linear and rotational movements that can be made with a user's hand. As one example, a free standing joystick is disclosed, which includes a hand-held fixture and eight accelerometers attached to the fixture. The accelerometers are mounted on the fixture so as to detect and distinguish the six freedoms of movement, linear motion along the X, Y, and Z axes, and rotations about those axes. The fixture is unencumbered by mechanical attachment and can be moved freely by the user. The accelerometers detect acceleration on the six degrees of freedom and can provide those movements to other entities such as a computer for use in games, space, and any application that may require input in multiple axes of freedom. The result is a computer input device that is more intuitive, more flexible, and can be produced at a lower cost than heretofore possible.

### FIELD OF THE INVENTION

The present invention relates generally to the field of computer input devices, and more specifically, but not exclusively, to a free standing joystick with an unrestricted 6 degrees of freedom (6DOF) that can detect and represent all of the movements made with a user's hand.

### BACKGROUND OF THE INVENTION

A joystick is a computer input device that translates the motion (e.g., force) of a user's hand into electronic information that a computer can process. At its inception, the joystick presented a significant improvement over the computer mouse, because the joystick provided an input device that more closely represented users' movements in the real world. Nevertheless, a significant problem with today's joysticks is that they are mechanically mounted to a physical base and also to the measurement devices that the joysticks employ. Consequently, the existing joysticks are significantly restricted in terms of their degrees of freedom of movement, and thus limited in their ability to detect all of the natural movements that can be made with a hand.

For example, U.S. Pat. No. 5,854,622 to Brannon (1998) discloses a 6DOF joystick that converts the force of hand movements into electrical output signals. However, the technical advantages of this joystick are not fully realizable, because the physical structure of the device allows it to be moved in only two dimensions. Also, this joystick's use of force as the primary input parameter is an approach that can be improved. For example, if a user desires to input an upward movement, the user must apply an upward force to the joystick and maintain that force for a significant period of time. The user does not actually move the joystick a significant distance. This approach could be improved by allowing the user to actually move the joystick upward so as to represent the input desired. However, such an improvement would be very complex, because it would require the use of up to eight mechanical devices, along with associated connecting hardware and multiple electrical connections. As such, the relatively high parts count and complex assembly processes needed for such an improvement to this approach would result in excessive design and manufacturing costs. Furthermore, such a large parts count and significant number of moving mechanical joints would create an increased risk of failure and attendant cost of repair.

In summary, there are numerous different joystick approaches described in the art, but no joystick currently exists that is unrestricted in terms of degrees of freedom of movement, and can detect and represent all of the movements that can be made with a user's hand. Therefore, a pressing need exists for a free standing joystick that is unrestricted in terms of degrees of freedom of movement, and can detect and represent all of the movements that can be made with a user's hand. As described in detail below, the present invention provides such a free standing joystick, which resolves the above-described joystick problems and other related problems.

### SUMMARY OF THE INVENTION

The present invention provides a free standing joystick that is unrestricted in terms of its DOF of movement, which can detect and represent all of the linear and rotational movements that can be made with a user's hand. In accordance with a preferred embodiment of the present invention, a free standing joystick is provided, which includes a hand-held fixture and eight Micro-electromechanical Systems (MEMS) accelerometers attached to the fixture. Two of the MEMS accelerometers are paired and mounted on the fixture in order to detect roll and X axis acceleration on the Y axis of the apparatus, with their axis of sensitivity along the X axis. One of that pair of accelerometers is mounted on one side of the center of rotation of the fixture, and the second accelerometer of that pair is mounted on the other side. If the fixture is moved and accelerated along its X axis, the two accelerometers will detect accelerations in the same direction. If the fixture is rotated about the X axis, the two accelerometers will detect accelerations in opposite directions. Movements consisting of combinations of linear and rotational movement will result in the sensing of the appropriate ratio of accelerations between the two sensors. Analysis of the data from the two accelerometers can extract and separate the two motions (linear and rotational) and make them available for further use. A second pair of MEMS accelerometers is mounted on the fixture in order to detect positive and negative pitch and Y axis accelerations, and a third pair of accelerometers is mounted on the fixture to detect positive and negative Z axis accelerations. A fourth pair of MEMS accelerometers is mounted on the fixture to detect positive and negative yaw accelerations. Consequently, the joystick can detect and output measurements of linear and rotational accelerations with 6DOF. The output of the apparatus can be conveyed to a computer over a wireless data link, which provides a joystick with essentially unrestricted movement that can output measurements of linear and rotational movement with 6DOF.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of an example free standing joystick, which can be used to implement a preferred embodiment of the present invention;

FIG. 2 depicts a pictorial representation of an example section of a fixture for a joystick, which illustrates details of the top portion of the section of the fixture shown in FIG. 1; and

FIGS. 3A and 3B are related pictorial representations depicting an example free standing joystick, which can be used to implement a second preferred embodiment of the present invention.

### DETAILED DESCRIPTION OF PREFERRED EMBODIMENT

The present invention provides a human controlled device used to input up to 6DOF information to a computer or other type of computing device. The term “6DOF” refers to the conventional six types of motion. These 6DOF include three DOF in rotation and three DOF in linear motion. The rotational movements are commonly known as yaw, pitch, and roll. A nautical definition can be used for linear motion, and the movements described in reference to a ship at sea. The term “surge” refers to forward and backwards motion (e.g., motion along the Y axis), “heave” means up and down motion (e.g., motion along the Z axis), and “sway” means left and right motion (e.g., motion along the X axis).

In accordance with principles of the present invention, an embodiment of an apparatus used to input 6DOF information into a computer may be constructed to include two primary components: 1) a fixture; and 2) a plurality of acceleration sensors. In one example embodiment of the present invention, the fixture is a physical device that a user can hold for manipulation, which also serves as a mounting device for a plurality of acceleration sensors (e.g., retained in specified positions in relationship to each other). In a second example embodiment, the fixture can be a physical device that can be attached to a user's body (e.g. head, torso, etc.), so that the apparatus can detect 6DOF motion of the user's head, body, etc. and input or report the 6DOF data to a computer.

With reference now to the figures, FIG. 1 depicts a pictorial representation of an example free standing joystick 100, which can be used to implement a preferred embodiment of the present invention. For this example embodiment, joystick 100 includes a fixture 102 and a plurality of sensors 104a-104h attached to fixture 102. The location of each sensor 104a-104h is indicated generally by the respective arrow shown. Fixture 102 includes three sections 106, 108 and 110, which are rod-like components attached together at their respective centers. Sections 106, 108 and 110 are mutually perpendicular. For this example embodiment, it may be assumed that section 106 is aligned with the pitch axis of fixture 102, section 108 is aligned with the yaw axis, and section 110 is aligned with the roll axis of fixture 102. As such, for rotational movement, sensors disposed on the ends of section 108 can sense accelerations in pitch and roll for fixture 102, and sensors disposed on the ends of section 110 can sense accelerations in yaw. For linear movement, sensors disposed on the ends of section 106 can sense accelerations in the Z axis for fixture 102, and sensors disposed on the ends of section 108 can sense accelerations on or about the X and Y axes for fixture 102. Also, it may be assumed for this example embodiment that fixture 102 is a hand-held apparatus, and its 6DOF movement can be controlled by a human hand.

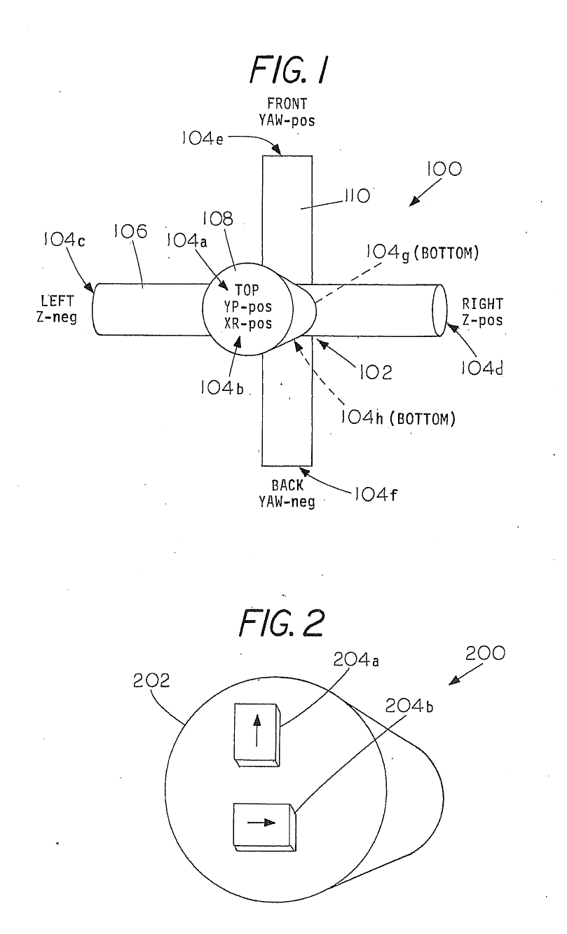

FIG. 2 depicts a pictorial representation of an example section 200 of a fixture for a joystick, which illustrates details of the top portion of section 108 of fixture 102 shown in FIG. 1. For this example embodiment, two accelerometers 204a, 204b are disposed on a top surface 202 of section 200. Arrows are used to show the direction of the axis of sensitivity of accelerometers 204a and 204b (e.g., and accelerometers 104a and 104b in FIG. 1). The direction of an arrow shows the direction of motion that is to be regarded as positive motion, motion opposite the arrow is to be regarded as negative motion, and motion substantially not in alignment with the arrow is to be regarded as motion not sensed by the particular sensor involved. As such, sensor 204a in this illustrative diagram can represent sensor 104a in FIG. 1, and sensor 204b can represent sensor 104b.

Notably, for a preferred embodiment of the present invention, accelerometers 204a and 204b (e.g., and all of the accelerometers 104a-104h in FIG. 1) are implemented with individual MEMS accelerometers. A MEMS accelerometer can include mechanical elements, sensors, actuators, and electronics arranged on a common silicon substrate using known micro-fabrication technologies. As such, a MEMS accelerometer is a complete sensor system on a chip. Using advanced micro-fabrication techniques, a MEMS accelerometer can also include a subminiature wireless transmitter. Consequently, the acceleration data outputs of the MEMS accelerometers shown in FIGS. 1 and 2 can be transmitted over respective wireless data communication links to an external receiver for processing, or alternatively, the acceleration data output of each MEMS accelerometer can be coupled to a wireless data communication transmitter (for wireless transmission to an external receiver) attached to the fixture involved. In any event, although the use of MEMS accelerometers is preferred, the present invention is not intended to be so limited and can include the use of any suitable device capable of sensing an acceleration of linear and rotational movement, and outputting suitable signals representing such sensed acceleration information.

Referring now to FIGS. 1 and 2, the following description explains how the eight accelerometers 104a-104h shown in the embodiment illustrated in these figures can detect and output 6DOF information. For this example embodiment, the two letter reference YP refers to the accelerometers 104a (top) (also 204a) and 104g (bottom) that have their axis of sensitivity aligned with the Y axis and sense surge and pitch. The two letter reference XR refers to the accelerometers 104b (top) (also 204b) and 104h (bottom) that have their axis of sensitivity aligned with the X axis and sense sway and roll. The reference Z refers to the accelerometers 104c (left) and 104d (right) that have their axis of sensitivity aligned with the Z axis and respectively sense heave and roll. The reference YAW refers to the accelerometers 104e (front) and 104f (back) that have their axis of sensitivity aligned with the X axis and sense yaw and sway. As such, it should be understood that the modifiers top, bottom, left, right, front, and back refer to the user's perspective when the fixture is held with the labeled ends pointing in their respective directions.

In operation, for this example embodiment, a user can grasp fixture 102 and move it in any direction with 6DOF. The accelerometers 104a-104h attached to fixture 102 can sense that motion and output suitable signals as positive and negative accelerations. The acceleration information signals are transmitted to an external receiver, and the acceleration information is provided to a computer or computing device to analyze and quantify the 6DOF motion involved. The computer or computing device can translate the raw data from the accelerometers into other suitable forms as may be desired. In a preferred embodiment, the accelerations are recorded and translated into velocity with respect to the various axes involved. The velocities can be translated into positional displacements, and the positional displacements can be translated into actual position information. As such, the resulting units of information, acceleration, velocity, displacement, and position may be utilized as desired. It should be noted that all, some, or none of the positional computations can be done by devices attached directly to the fixture.

In accordance with principles of the present invention, the arrangement of accelerometers 104a-104h on fixture 102 (e.g., as shown in the example embodiment of FIG. 1) provides the ability to sense both linear and rotational motion, and generate 6DOF information. For clarity purposes, it is useful to describe in more detail how the present invention provides the ability to sense and report these motions. For example, referring to FIG. 1, a forward movement can be used to typify linear acceleration. Thus, if a user accelerates fixture 102 in a forward direction (front) with no rotational movement, accelerometers 104a (YP-top) and 104g (YP-bottom) both sense the same acceleration rate with the same polarity. The outputs from these two accelerometers can be averaged together, and this average used as the value for linear acceleration along the Y-axis (e.g., forward movement). A generalized and simplified relationship for linear acceleration is (YP-top+YP-bot)/2=forward acceleration. Thus, for a typical acceleration of 200 mm per second squared, the result would be (200+200)/2=linear acceleration in mm per second squared, or 200 mm per second squared. This measurement value indicates that fixture 102 is being accelerated in the forward direction at the rate of 200 mm per second squared.

As another example, a pitch movement can be used to typify rotational acceleration. A typical rotational acceleration is a forward pitch rotation, whereby the YP top accelerometer 104a is accelerated forward along its axis of sensitivity (e.g., at the rate of 200 mm per second squared). The YP bottom accelerometer 104g, which is located on the opposite side of the center of gravity of fixture 102, and also the opposite side of the center of rotation of fixture 102, is accelerated towards the rear (e.g., at the rate of 200 mm per second squared). In this case, the YP top accelerometer 104a senses a positive acceleration, and the YP bottom accelerometer 104g senses a negative acceleration. Notably, the fact that the acceleration polarities are different indicates that the acceleration is rotational instead of linear. A generalized and simplified relationship for rotational acceleration rate is (YP bottom-YP- top)/2=rotational acceleration. Thus, for a typical rate of 200 mm per second squared, the result would be ((−200)−(+200))/2=rotational acceleration in mm per second squared, or −200 mm per second squared. This measurement value indicates that fixture 102 is experiencing a negative rotational acceleration, and that YP top accelerometer 104a and YP bottom accelerometer 104g are accelerating along the circumference of their mounting circle at the rate of 200 mm per second squared. The rate of rotation in degrees can be calculated from these values, and the acceleration value can be integrated into velocity and position information. Given this information, the pitch angle of fixture 102 can be tracked and known at any given instant. Notably, the above-described example typifies fundamental attitude sensing without the need for gyroscopic information for assistance.

For this example embodiment, linear and rotational acceleration information can be separated in the following manner. If the above-described typified forward linear acceleration along the Y-axis is processed using the above-described rotational relationship, the results are as follows. The linear acceleration results in the accelerometers measuring the same rates with the same polarity. Thus, (YP bottom-YP top)/2=rotational acceleration, or ((+200)−(+200))/2=0. In other words, the rotational acceleration rate in this case is zero. This result demonstrates that using the difference in the two acceleration rates removes the linear component of acceleration, which leaves only the rotational component.

Rotational acceleration results in values with opposite signs. For example, if the above-described typified rotational acceleration is processed using the above-described linear equation, the results are as follows: (YP bottom+YP-top)/2=forward acceleration, or ((−200)+(+200))/2=0. In other words, the rotational acceleration rate is zero. This result demonstrates that using the average of the two acceleration rates removes the rotational component of acceleration, which leaves only the linear component. As such, these calculations show that the present invention can separate linear acceleration from rotational acceleration. Thus, linear acceleration can be derived by averaging the sum of the two accelerometers involved, and rotational acceleration can be derived by averaging the difference between the two accelerometers involved.

Additionally, for this example embodiment, accelerometers XR top 104b and XR bottom 104h sense linear acceleration along the X-axis (left and right) and also roll. Accelerometers Z right 104d and Z left 104c sense linear acceleration up and down, and accelerometers Yaw front 104e and Yaw back 104f sense yaw acceleration. The calculations for each of these pairs of accelerometers can use the same relationships as those described above for the YP top and YP bottom pair, by substitution of the specific accelerometers being used.

It should be noted that the present invention is not intended to be limited to orthogonal configurations and encompasses within its scope accelerometers that can be mounted in suitable non-orthogonal configurations so as to reduce the sensor count and/or provide redundancy. As such, the above-described use of an orthogonal configuration is provided solely for illustrative purposes and ease of description.

It should be noted that while the described embodiment is implemented with accelerometers, it is not intended to be restricted to accelerometers. A paired accelerometer configuration as described here effectively synthesizes a gyroscope. As technology advances, MEMS gyroscopes or other types of gyroscopes may be incorporated into this design. The fundamental concept remains: attach motion and position sensing devices to a fixture for the purpose of sensing the motions and positions of that fixture and communicating these motions and positions to other devices for use, and further that this fixture may itself be or remain unattached to other devices providing unfettered movement for the convenience of the user.

It should be further noted that such fixtures as described here are not restricted to hand-held uses. Such devices may take other forms and may be mounted to hands, feet, heads, and other bodily parts. They may be further mounted to various parts of other living entities, or mechanical and biological devices.

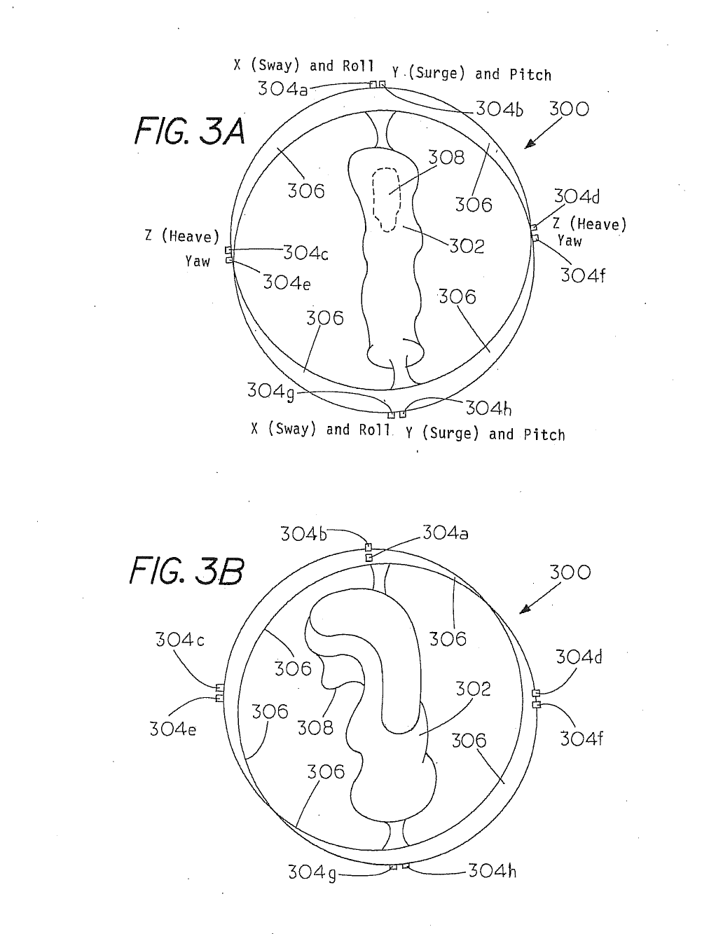

In this regard, FIGS. 3A and 3B are related pictorial representations depicting an example free standing joystick 300, which can be used to implement a second preferred embodiment of the present invention. Essentially, FIGS. 3A and 3B respectively depict a back view and perspective side view of joystick 300. Referring to FIGS. 3A and 3B, for this example embodiment, joystick 300 includes a handle 302 and a ring structure 306 attached to each end of handle 302. Handle 302 includes a trigger-type (input) switch device 308. A plurality of acceleration sensors 304a-304h is attached to ring 306. For this example embodiment, it may be assumed that joystick 300 is a hand-held apparatus, and its 6DOF movement can be controlled by a human hand.

For this example embodiment, sensors 304a (top) and 304g (bottom) are oriented as X acceleration sensors that sense sway and roll, and their axes of sensitivity are to the right and left in FIGS. 3A and 3B. Sensors 304b and 304h are oriented as Y acceleration sensors that sense surge and pitch, their axes of sensitivity are front to back (into and out of FIGS. 3A and 3B), and they are attached at right angles to the X sensors 304a and 304g. Sensors 304c and 304d point up and down in FIGS. 3A and 3B and are oriented as Z acceleration sensors that sense heave (Up and down) and roll. Sensors 304e and 304f point fore and aft (in and out) in FIGS. 3A and 3B, and are oriented as yaw acceleration sensors that can also sense surge.

An example of the operation and use of a 6DOF joystick structured in accordance with the second preferred embodiment of the present invention is now described. For clarity, the following assumptions can be made. For this example embodiment, it may be assumed that joystick 300 in FIGS. 3A and 3B is being used, the joystick will input data to a program installed on a computer, the program is a game involving a spaceship, and the spaceship is not subject to gravity and can move and rotate in any direction with equal ease. As such, it should be understood that a user's activities with the example joystick described herein are arbitrary and provided for the purpose of explanation only. Also, the characteristics of an arbitrary computer program described herein are synthesized and used purely for illustrative purposes.

A user can start the program and initialize it to the point where it displays the spacecraft and is ready to accept inputs from the joystick involved. For this example embodiment, the user grasps handle 302 by hand, so that the user's wrist is free to rotate in the vertical and horizontal planes. The user may press trigger input switch 308 on handle 302 to calibrate joystick 300. This calibration could be used to indicate to the computer that joystick 300 is now at the center of its movement range. For example, while joystick 300 is in this centered position, the program would make no changes in the attitude or velocity of the spaceship being displayed. Thus, if the spaceship is moving forward, it will continue to move forward at the current velocity and direction. This centered position of joystick 300 can be referred to as the rest position. All user movements can be interpreted by the computer program with respect to this rest position.

Next, for this example, it may be assumed that the user views the spaceship on the computer display, and decides to move the spaceship forward. To accomplish this function, the user simply moves the hand that is grasping handle 302 directly forward away from the rest position. The Y-Pitch acceleration sensors 304b, 304h located at the top and bottom of ring 306, sense this linear acceleration and provide that information for transmission to the computer program. The program analyzes the inputs from joystick 300 and determines that it has been moved forward. The program determines the amount that joystick 300 has been moved, and causes the spaceship in the program to accelerate forward. The rate of acceleration is dependent on the distance the user has moved joystick 300 from the rest position. The further the distance joystick 300 has been moved, the higher the rate of acceleration. At some point, the user determines that the spaceship's forward velocity is sufficient and returns joystick 300 to its rest position. As a result, the spaceship stops accelerating and continues to move forward at its current velocity. The program can be created to evaluate the speed at which the user moves the fixture, and incorporate that into movements of the spaceship.

If the user determines that the desired location of the spaceship within the computer's virtual environment will soon be reached, the user can pull joystick 300 backwards from its rest position by a certain amount. As described above, the movement of joystick 300 is analyzed by the computer program, which begins to slow the movement of the spaceship. In other words, the computer program applies a negative acceleration. When the spaceship's velocity is zero, the user can move joystick 300 to the rest position, and the spaceship will remain in its current position with no velocity.

The user can repeat the above-described operations, but this time the user pulls joystick 300 backward rather than pushing it forward to initiate motion. If the ensuing user events are substantially identical to the above-described forward events but in reverse, the spaceship will perform the same operations in a backwards direction instead of a forward direction. Similar operations can be repeated by the user for left, right, up, and down motions with the expected logical results.

If the user wishes the spaceship to turn right, the user simply rotates joystick 300 to the right. For this example embodiment, the YAW acceleration sensors 304e and 304f sense this motion. In a manner similar to that described above for linear acceleration, as the user rotates fixture 302 further away from the rest position, the computer program responds by rotating the spaceship faster. In any event, one of ordinary skill should be able to understand these movement relationships. All combinations of linear and rotational movements can be sensed by the acceleration sensors attached to joystick 300 and this information conveyed to the computer involved, and all of these linear and rotational movements of joystick 300 can be translated by the computer's program into movements of the spaceship being displayed.

It is important to note that while the present invention has been described in the context of a fully functioning free standing joystick, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular free standing joystick.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A motion sensing apparatus, comprising:
a fixture; and
a plurality of acceleration sensors attached to said fixture, said plurality of acceleration sensors adapted to sense a first plurality of positive and negative linear movements of said fixture and a second plurality of rotational movements of said fixture.

2. The motion sensing apparatus of claim 1, wherein said fixture and said plurality of acceleration sensors comprise a joystick.

3. The motion sensing apparatus of claim 1, wherein said fixture comprises three rod-like sections attached together at a common centerline and arranged mutually perpendicular.

4. The motion sensing apparatus of claim 1, wherein said fixture comprises a handle and a spherically-shaped device attached to each end of said handle.

5. The motion sensing apparatus of claim 1, wherein said plurality of acceleration sensors comprises a plurality of MEMS devices.

6. The motion sensing apparatus of claim 1, wherein said plurality of acceleration sensors comprises four pairs of acceleration sensors, a first acceleration sensor of each of said four pair is operable to sense a positive acceleration, and a second acceleration sensor of each said pair is operable to sense a negative acceleration.

7. The motion sensing apparatus of claim 1, wherein said plurality of accelerations sensors comprises at least one pair of sensors operable to sense linear motion and rotational motion by analyzing the sum and difference of the sensed information.

8. The motion sensing apparatus of claim 1, wherein at least one pair of said plurality of acceleration sensors comprises a first accelerometer with an axis of sensitivity oriented perpendicular to an axis of sensitivity of a second accelerometer.

9. The motion sensing apparatus of claim 1, wherein said plurality of acceleration sensors comprises a Y-pitch positive acceleration sensor, a Y-pitch negative acceleration sensor, an X-roll positive acceleration sensor, an X-roll negative acceleration sensor, a right Z positive acceleration sensor, a left Z negative acceleration sensor, a front yaw positive acceleration sensor, and a back yaw negative acceleration sensor.

10. The motion sensing apparatus of claim 1, wherein said fixture is adapted to move in synchronization with movement of a user's head.

11. The motion sensing apparatus of claim 1, wherein said fixture is adapted to move with or be moved by a person, animal or machine.

12. The motion sensing apparatus of claim 1, wherein said plurality of acceleration sensors are arranged in at least one of an orthogonal configuration and a non-orthogonal configuration including a plurality of sensors such that a movement along or about six degrees of freedom can be sensed, categorized, or made available for analysis or use.

13. A motion sensing apparatus, comprising:
means for conveying movement in a three dimensional space; and
means, attached to said means for conveying, for sensing a first plurality of positive and negative linear movements of said means for conveying, and a second plurality of rotational movements of said means for conveying.

14. The motion sensing apparatus of claim 13, wherein said means for conveying movement and said means for sensing comprise a joystick.

15. The motion sensing apparatus of claim 13, wherein said means for conveying comprises three rod-like sections attached together at a common centerline and arranged mutually perpendicular.

16. The motion sensing apparatus of claim 13, wherein said means for conveying movement comprises a ring-shaped structure, and said means for sensing comprises a plurality of accelerometers attached to said ring-shaped structure.

17. The motion sensing apparatus of claim 13, wherein said means for sensing comprises a plurality of MEMS devices.

18. A method for sensing movement, comprising the steps of:
attaching a plurality of acceleration sensors to a fixture;
a first plurality of said plurality of acceleration sensors sensing positive and negative linear movements of said fixture; and
a second plurality of said plurality of acceleration sensors sensing positive and negative rotational movements of said fixture.

19. The method of claim 18, wherein the attaching step comprises the steps of:
attaching three rod-like sections together at a common centerline; and
orienting said rod-like sections perpendicular to each other.

20. The method of claim 18, wherein the fixture comprises a handle and a ring structure attached to said handle.
